(19) United States
(12) Patent Application Publication
(10) Pub. No.: US 2011/0145822 A1
(43) Pub. Date: Jun. 16, 2011

(54) GENERATING AND RECOMMENDING TASK SOLUTIONS

(75) Inventors: Tiffany Rowe, Chandler, AZ (US); Joseph Miller, Chandler, AZ (US); Yong Lee, Chandler, AZ (US)

(73) Assignee: THE GO DADDY GROUP, INC., Scottsdale, AZ (US)

(21) Appl. No.: 12/634,950

(22) Filed: Dec. 10, 2009

(51) Int. Cl. G06F 9/46; G06F 15/18; G06F 17/30

(52) U.S. Cl. 718/100; 706/12; 707/770

(57) ABSTRACT

Systems and methods of the present invention provide for receiving an action item communication by a user, which is then imported by a task management engine into a task list of an electronic organizer. Keywords from the task may be used to search a user's preferences, partnerships or the Internet for suggested solutions to complete the task. The system may then be customized to the user's preferences.

### CROSS REFERENCE TO RELATED PATENT APPLICATIONS

This patent application is related to the following concurrently-filed patent applications:

U.S. patent application Ser. No. ______, “TASK MANAGEMENT ENGINE.”

The subject matter of all patent applications is commonly owned and assigned to The Go Daddy Group, Inc. All prior applications are incorporated herein in their entirety by reference

### FIELD OF THE INVENTION

The present inventions generally relate to the field of electronic organizers and specifically to the field of transferring a series of communications and tasks within an electronic organizer to a task list and recommending a course of action for each task.

### SUMMARY OF THE INVENTION

The present invention provides methods and systems for recommending a course of action to a user of an electronic organizer for the tasks within a task list. An exemplary method may comprise several steps including the step of generating one or more action items. A Task Management Engine or TME, comprising data from a data source and one or more software modules executed on a server or client within a data center may import one or more action items from one or more client machines into a task list within the electronic organizer. The TME may then extract key action words, and use these key action words to search an existing user profile, various information related to third party partnerships and the Internet to generate recommended solutions for the action item(s) and set reminders for due dates. This list of recommendations may then be displayed to the user, and the system may learn from the decisions or preferences selected by the user.

The above features and advantages of the present invention will be better understood from the following detailed description taken in conjunction with the accompanying drawings.

### BRIEF DESCRIPTION OF THE DRAWINGS

FIG. 1 is a flow diagram illustrating a possible embodiment of a method for generating an action item and recommending a solution to complete the action item.

FIG. 2 illustrates a possible system in which an action item may be generated and a possible solution recommended to complete the action item.

FIG. 3 is a flow diagram illustrating a possible embodiment including flagging a communication, parsing, extracting and importing key words into a task list and searching for a recommended solution.

FIG. 4 illustrates a possible embodiment of an interface for flagging a communication, parsing, extracting and importing key words into a task list and searching for a recommended solution.

FIG. 5 is a flow diagram illustrating a possible embodiment including receiving a proposed solution, marking the task as complete and updating the profile.

FIG. 6 illustrates a possible embodiment of an interface for receiving a proposed solution, marking the task as complete and updating the profile.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers place multimedia information (e.g., text, graphics, audio, video, animation, and other forms of data) at specific locations on the Internet referred to as websites. The combination of all the websites and their corresponding web pages on the Internet is generally known as the World Wide Web (WWW) or simply the Web.

An electronic calendar or electronic organizer is a software application that enables users to have electronic versions of commonly-used office tools, such as a calendar, appointment book, address book, contact list, and/or task manager. Electronic calendars have become a common and convenient way of keeping track of events, such as appointments, meetings, action items, task lists, etc. They permit users to manage their calendar and task data (e.g., adding contact information, scheduling meetings, blocking out vacation time or arranging and organizing tasks) via an easily accessible and manipulatable user interface. Electronic calendars may run on—and be accessed by—virtually any electronic device including a desktop computer, laptop computer, hand held computer, personal digital assistant, and/or cellular or wireless phone. Most electronic calendars and electronic organizers are either web-based or client-based.

Web-based electronic calendars and electronic organizers operate via software residing on servers that are accessible via a client electronic device connected to the Internet. Examples of web-based electronic calendars include GODADDY.COM ONLINE GROUP CALENDAR, GOOGLE CALENDAR, YAHOO CALENDAR, and MICROSOFT WINDOWS LIVE CALENDAR. Such calendars may be accessed over the Internet by virtually any client. Client-based electronic calendars and electronic organizers, on the other hand, operate via software residing on the client and generally may be accessed only via that client. Examples of client-based electronic calendars include MICROSOFT OUTLOOK.

A Method for Recommending a Solution to a Generated Task in a Task List

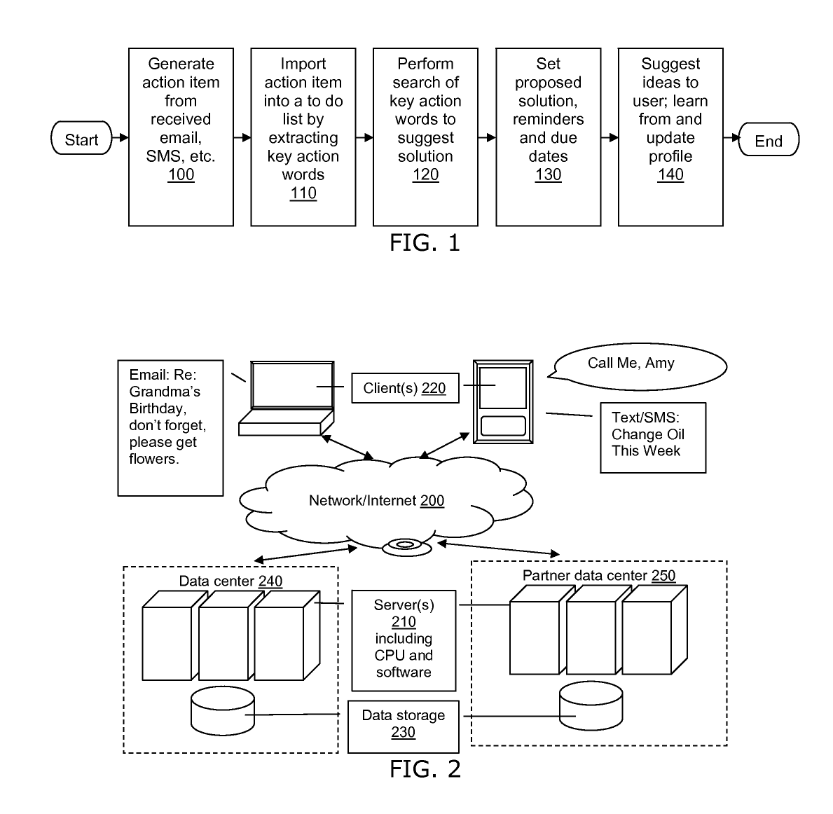

Several different methods may be used to provide and manage the disclosed invention. In an example embodiment illustrated in FIG. 1, an action item for the user may be generated from email, voicemail, SMS, text, or any other communication that conveys an action item with information to be imported into a task list (Step 100). The Task Management Engine (TME), comprising data from a data source and one or more software modules executed on a server or client within a data center may use any combination of software modules on a server and client and any related data stored in data storage used to import the action items into a task list. (Step 110). The TME may extract key action words (Step 110), and these key action words may be used to search an existing user profile, information stored in a database relating to third party partnerships or the Internet (Step 120), the results of which may be used to generate recommendations and/or proposed solutions and set reminders for due dates (Step 130). The TME may then present a list of recommendations and/or proposed solutions to the user, and the TME may learn from the response to these suggested solutions, as well as preferences and ratings received from the user and update the profile accordingly (Step 140).

Several different environments may be used to accomplish the steps of embodiments disclosed herein. FIG. 2 demonstrates a streamlined example of such an environment and illustrates a non-limiting example of a system and/or structure that may be used to accomplish the methods and embodiments disclosed and described herein. Such methods may be performed by any central processing unit (CPU) in any computing system, such as a microprocessor running on at least one server 210 and/or client 220, and executing instructions stored (perhaps as scripts and/or software, possibly as software modules) in computer-readable media accessible to the CPU, such as a hard disk drive on a server 210 and/or client 220.

The example embodiments shown and described herein exist within the framework of a network 200 and should not limit possible network configuration or connectivity. Such a network 200 may comprise, as non-limiting examples, any combination of the Internet, the public switched telephone network, the global Telex network, computer networks (e.g., an intranet, an extranet, a local-area network, or a wide-area network), a wired network, a wireless network, a telephone network, a corporate network backbone or any other combination of known or later developed networks.

At least one server 210 and at least one client 220 may be communicatively coupled to the network 200 via any method of network connection known in the art or developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM), Infrared Data Association (IrDA), wireless, WAN technologies (T1, Frame Relay), Point-to-Point Protocol over Ethernet (PPPoE), and/or any combination thereof.

The server(s) 210 and client(s) 220 (along with the software modules disclosed herein) may be communicatively coupled to the network 200 and to each other in such as way as to allow a user to extract, generate and/or import action items from a received voicemail, email, SMS, text, etc., to extract and/or parse key action words to import and/or search key words to search for solutions for a task in a task list, to access partner information in a partner data center 250 (described in detail below), to recommend a proposed solution based on the partner information, and/or searches of profile and/or Internet solutions, to set due dates for the task, to learn from and update the user's profile and/or accomplish any other methods disclosed herein.

The example embodiments herein place no limitations on whom or what may comprise users. Thus, as non-limiting examples, users may comprise any individual, entity, business, corporation, partnership, organization, governmental entity, and/or educational institution that may have occasion to schedule an event in an electronic calendar or organizer.

Such server(s) 210 may comprise any computer or program that provides services to other computers, programs, or users either in the same computer or over a computer network 200. As non-limiting examples, the server 210 may comprise application, communication, mail, database, proxy, fax, file, media, web, peer-to-peer, standalone, software, or hardware servers (i.e., server computers) and may use any server format known in the art or developed in the future (possibly a shared hosting server, a virtual dedicated hosting server, a dedicated hosting server, a cloud hosting solution, a grid hosting solution, or any combination thereof) and may be used, for example to provide access to the Internet, user profile, partner content and/or other data requested by a client 220.

The server 210 may exist within a server cluster, as illustrated. These clusters may include a group of tightly coupled computers that work together so that in many respects they can be viewed as though they are a single computer. The components may be connected to each other through fast local area networks which may improve performance and/or availability over that provided by a single computer.

The software modules used in the context of the current invention may be stored in the memory of—and run on—at least one server 210. As a non-limiting example of such software modules, a keyword extraction module may be used to extract keywords from the action item and/or action item communication to suggest solutions for the task within the task list. Using these keywords, the keyword extraction module may extract keywords used to search for a recommended solution for the task. A task solution suggestion module may likewise be used to suggest solutions to complete a task based on the results of the searched keywords, etc. The software modules may comprise software and/or scripts containing instructions that, when executed by a microprocessor on a server 210 or client 220, cause the microprocessor to accomplish the purpose of the module, in this example to extract keywords from an action item or action item communication, search the keywords for possible solutions and/or recommend the resulting solutions to the user.

The client 220 may be any computer or program that provides services to other computers, programs, or users either in the same computer or over a computer network 200. As non-limiting examples, the client 220 may be an application, communication, mail, database, proxy, fax, file, media, web, peer-to-peer, or standalone computer, cell phone, personal digital assistant (PDA), etc. which may contain an operating system, a full file system, a plurality of other necessary utilities or applications or any combination thereof on the client 220. Non limiting example programming environments for client applications may include JavaScript/AJAX (client side automation), ASP, JSP, Ruby on Rails, Python's Django, PHP, HTML pages or rich media like Flash, Flex or Silverlight.

The client 220 that may be used to connect to the network 200 to accomplish the illustrated embodiments may include, but are not limited to, a desktop computer, a laptop computer, a hand held computer, a terminal, a television, a television set top box, a cellular phone, a wireless phone, a wireless hand held device, an Internet access device, a rich client, thin client, or any other client functional with a client/server computing architecture. Client software may be used for authenticated remote access to a hosting computer or server. These may be, but are not limited to being accessed by a remote desktop program and/or a web browser, as are known in the art.

The user interface displayed on the client 220 or the server 210 may be any graphical, textual, scanned and/or auditory information a computer program presents to the user, and the control sequences such as keystrokes, movements of the computer mouse, selections with a touch screen, scanned information etc. used to control the program. Examples of such interfaces include any known or later developed combination of Graphical User Interfaces (GUI) or Web-based user interfaces as seen in and after FIG. 4, Touch interfaces, Conversational Interface Agents, Live User Interfaces (LUI), Command line interfaces, Noncommand user interfaces, Object-oriented User Interfaces (OOUI) or Voice user interfaces. The action item generated, or any other information, may be accepted using any field, widget and/or control used in such interfaces, including but not limited to a text-box, text field, button, hyper-link, list, drop-down list, check-box, radio button, data grid, icon, graphical image, embedded link, etc.

The server 210 may be communicatively coupled to data storage 230 of electronic calendar information, task management information, or any other information requested. The data storage 230 may be any computer components, devices, and/or recording media that may retain digital data used for computing for some interval of time. The storage may be capable of retaining stored content for the calendar data, task data, profile data, partner data, search tool data or any other data requested, on a single machine or in a cluster of computers over the network 200, in separate memory areas of the same machine such as different hard drives, or in separate partitions within the same hard drive, such as a database partition.

Non-limiting examples of the data storage 230 may include, but is not limited to, a Network Area Storage, (“NAS”), which may be a self-contained file level computer data storage connected to and supplying a computer network with file-based data storage services. The storage subsystem may also be a Storage Area Network (“SAN”—an architecture to attach remote computer storage devices to servers in such a way that the devices appear as locally attached), an NAS-SAN hybrid, any other means of central/shared storage now known or later developed or any combination thereof.

Structurally, the data storage 230 may comprise any collection of data. As non-limiting examples, the data storage 230 may comprise a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, and/or other means of data storage such as a magnetic media, hard drive, other disk drive, volatile memory (e.g., RAM), non-volatile memory (e.g., ROM or flash), and/or any combination thereof.

The server(s) 210 or software modules within the server(s) 210 may use query languages such as MSSQL or MySQL to retrieve the content from the data storage 230. Server-side scripting languages such as ASP, PHP, CGI/Perl, proprietary scripting software/modules/components etc. may be used to process the retrieved data. The retrieved data may be analyzed in order to determine the actions to be taken by the scripting language, such as determining the action items received via voicemail, email, text, etc., key words to be matched to those found in the action item, solutions to be recommended based on the keywords determined, user preferences based on user history or profile, changes to the user's preferences or profile, updates to the user's profile, due dates for action items and when those action items were completed, or any other method steps disclosed herein.

In the context of the current invention, the client 220 may receive a voicemail, email, text, etc. and this communication may be compared with information in the user's profile via software modules executed on the server 210, client 220 and/or information in the data storage 230. The server may also contain one or more software modules used to process the communication and action item (possibly by importing, extracting and/or parsing key action words), access the data storage, and use the key action words to suggest a proposed solution, set the solution, set reminders and due dates and learn and update the profile as needed.

Another environment similar to the data center 240 may also be used to access information about a partner on a partner's server 210 in a partner's data center 250. As the user is accesses information about or from their electronic calendar and task list, another command from the software modules may be used to redirect to a partner's server 210 in a partner's data center 250. This server may also contain software components which allow a data storage 230, either separate from or integrated into the partner's server, to access information regarding available potential solutions to the necessary action item from the users. The partner's server 210 may use the partner's data storage 230 and software modules or components on the server 210 to search for solutions to be recommended to the user to accomplish their action items and/or task list items. If such a solution is available, the software modules or components on the server 210 and/or partner's server 210 may be used to forward this information from the data storage 230 to the user/potential customer. This information may also be forwarded to an email account of the user.

The action item to be scheduled, as non-limiting examples, may comprise any meeting, appointment, trip, holiday, vacation, delivery, reminder (e.g., birthday, anniversary, oil change, etc.), and/or any happening scheduled to occur at a particular time and/or place. As non-limiting examples, the electronic communication may comprise an electronic signal sent to an IP address, an email, an instant message, an HTTP request, and/or any other form of electronic signal to or from the electronic calendar to the user.

In a non-limiting example embodiment, the data center 240 and/or partner data center 250 may provide hosting services for the electronic calendar, or any related hosted website including, but not limited to hosting one or more computers or servers in a data center 240/250 as well as providing the general infrastructure necessary to offer hosting services to Internet users including hardware, software, Internet web sites, hosting servers, and electronic communication means necessary to connect multiple computers and/or servers to the Internet or any other network 200. These data centers 240/250 or the related clients 220 may accept messages from text messages, SMS, web, mobile web, instant message, third party API projects or other third party applications.

The electronic calendar or electronic organizer containing the task list may comprise a software application that enables the user to, among other things, have electronic access to commonly-used office tools, such as a calendar, appointment book, address book, contact list, and/or task manager. It may have the ability to display the user's calendar and/or task list in a plurality of different formats (e.g., hourly, daily, weekly, monthly views, upcoming deadlines, user priority of tasks, etc.). The electronic calendar/electronic organizer could be web-based, client-based, a stand-alone application, a component of a larger application, and/or any combination thereof. In one example embodiment the electronic calendar may reside on a server or client.

The electronic calendar software or electronic organizer application also may include calendaring and scheduling tools that may automatically check a user's electronic calendar for available meeting times, deadlines, suggest possible solutions to users based on partner, Internet or profile information, schedule user meetings and/or appointments and/or remind users of scheduled events. It could be web-based, client-based, a stand-alone application, a component of a larger application, and/or any combination thereof.

The TME and/or its user interface may be a component of the electronic calendar (irrespective of whether the calendar is web-based or client-based), or may encompass the entire system including software modules, disclosed hardware and/or data used in conjunction with the software modules, required to create the logic disclosed elsewhere in this application. Alternatively, the TME and/or user interface may reside on a separate server, client, or a second network communicatively coupled to the electronic calendar via the network 150, perhaps via a webpage on a website.

FIG. 1 shows that the illustrated embodiment, as well as other disclosed embodiments, may include the step of a user receiving an action item communication, such as an email, voice message, SMS, text message, etc., with an action item the user must complete by the end of a current time period (i.e. day, week, month) (Step 100).

FIG. 4 shows an example interface using the disclosed structure that may be used for receiving an action item communication, such as an email, voice message, SMS, text message, etc., with an action item the user must complete by the end of a current time period (Step 100). The events in the illustrated task list are for fictitious events, including “Buy flowers for Grandma's birthday,” “Get oil change” and “Return Amy's phone call.” These events (possibly displayed on a web based email, calendar organizer or within a related task list) may be displayed as shown on a client browser or other software using the structure disclosed herein, and may be used in disclosed embodiments to demonstrate an event extracted from a generated action item communication and displayed with recommendations, due dates, user profile information and updates to the user.

For example, John's spouse Amy may send him an email to remind him to buy flowers for grandma's birthday as seen in FIGS. 2 and 4. In the email shown in FIG. 4, the TME may use the logic, data, software and structure described elsewhere in this application to determine that the action item to be completed includes buying flowers for Grandma's birthday. The TME may further use keywords to determine that the deadline for buying the flowers is Thursday of the current week, according to the parsing and extracting of the action and task item described below.

Likewise, John may have received an SMS, text or other communication reminding him that he needs to get his oil changed this week, as the mileage has exceeded safe use for his previous oil change. This information may have been stored within John's user profile, allowing him to know the approximate time that the oil will need to be changed, based on his regular mileage, date of last several oil changes, or any other factors that would cause John to need to change his oil. Thus, the current time period is not limited to day, week, month, etc. In this example, the current time period may be determined by monitoring an occurrence that has happened regularly enough that the system recognizes the time period in which the occurrence will likely happen again, and may propose solutions based on this time period and possible deadline.

Finally, John may have received a voice mail from Amy, who may be wondering about John's plans on Friday (possibly for an anniversary or other regularly scheduled appointment), and may have left the voice message with instructions to return her call to set up an appointment. Any of these non-limiting examples may be valid action item communications used to extract action items during a current time period and the time frame in which they need to be accomplished. As seen in FIG. 2, these messages may be received on, but are not limited to, a client computer, hand held computer, cell phone, PDA, etc. In this example, as above, the TME system may further learn the time period in which the action item may occur in a time period such as an annual, monthly, weekly or daily event. Because of the repetitiveness of the event at regular intervals, the system may also learn to repeat suggestions for the event, and suggest solutions accordingly.

As seen by the final checkbox within the email, the communications for action items to be imported are not limited to this email, or even email generally. Other sources of action items may have similar menus or interfaces that allow the user to select from among sources, or to import action items from among all available sources. For example, a text message may have numbers that the user could text to (e.g. text 123 to “mycalendar” to import from all available other sources) in order to allow the user to select certain options, or a voice mail may include a voice menu, selecting certain numbers on a phone keypad (e.g. “select 1 now to import action items from all other sources”) allowing the user to select this or any other such option.

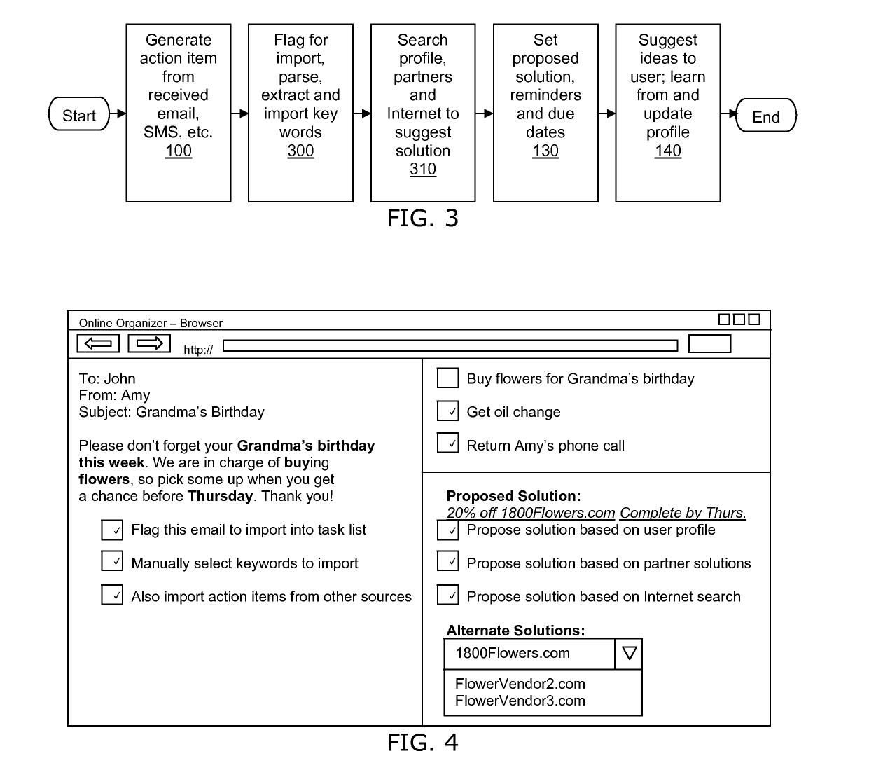

FIG. 3 shows that the illustrated embodiment, as well as other disclosed embodiments, may include the step of flagging the action item communication (such as the illustrated email) by the user so that the TME may import it into the task list (Step 300).

FIG. 4 shows an example interface using the disclosed structure that may be used for flagging the action item communication by the user so that the TME may import it into the task list (Step 300). For example, John may have flagged the email from his spouse Amy reminding him that his Grandmother's birthday is this Thursday, and that he and Amy are in charge of buying the flowers for the party. John may have flagged the email when received, in this non-limiting example, by clicking on a checkbox which begins the importing process into the task list.

FIG. 3 shows that the illustrated embodiment, as well as other disclosed embodiments, may include the step of the TME parsing the text of the action item communication for keywords and proposing a solution, by extracting keywords from the action item communication into the task list (Step 300), performing a profile, partner or Internet search, and suggesting solutions to perform the action item. (Step 310).

FIG. 4 shows an example interface using the disclosed structure that may be used for parsing the action item text for keywords and extracting keywords from the action item communication (Step 300). For example, the TME may import only the text, or possibly the entire email including HTML, images, links, etc. into John's task list. Likewise, voice recognition software may recognize the message left by Amy regarding John's plans for Friday, convert the voice recognized information into text and parse out individual key words to import either key words, or the entire message into the task list. The system may also parse information and key words from the text of an SMS or text message to get the oil changed.

In the illustrated example embodiment in FIG. 4, the TME may import the email into John's task list and may extract the keywords “Grandma's birthday,” “this week,” buying,” “flowers,” and “Thursday,” and focus on the keywords “buy” and “flowers” to search for recommended solutions and present them to the user.

In this example, the TME has determined that since John and his spouse are in charge of buying flowers for Grandma's birthday party, the TME may extract the keywords “buy” and “flowers” to search for recommended solutions. This may be accomplished, in this non-limiting example, by either highlighting the keywords that the TME considers the most relevant or allowing the user to select and/or highlight the keywords that the user considers most important. The TME's selection and/or highlighting of the most important keywords may be based on the logic above, analysis of the user's past experience, selections, actions, preferences and/or ratings, analysis of the user's profile (described below) or any combination thereof.

For example, based on analysis of the user's past experience, selections, actions, preferences, ratings, profile, etc., the TME may parse out the words from the text of the email in FIG. 4 and determine that the keywords in this email are “Grandma's birthday,” “buy,” “flowers” and “Thursday.” The user may similarly manually select the keywords that should be extracted and imported into the task list, possibly by highlighting them, selecting them from a list, selecting a series of checkboxes next to each of the presented words (described below), and/or any other method of selecting text and keywords known in the art.

In another example embodiment, the user may select, or the TME may use logic to determine, words that are common to all emails. For example, in this email, words such as “please,” “don't,” “your,” “of,” etc. may be common words that don't need to be extracted from the action item communication and imported into the task list, because they are so commonly used in emails sent and received by this user. Logic may exist within software modules to recognize and store these common words within the data source 230. This may allow the TME's logic or the user to more easily manually select (not shown) the keywords that should be extracted from the action item communication (the highlighted words in this example) and import and convert these as action items into the task list.

In another non-limiting example embodiment, the TME may either eliminate all commonly used words (i.e. “the,” “and,” “of,” etc., or any other words from a database or pre-selected by the user), or provide an interface (not shown) to allow the user to select the key words that the user would like to have available from this email, i.e. checkboxes next to the keywords that the user considers most important in this email, possibly via a checkbox wherein the user may display a window with checkboxes next to each of the words in the email to select those the user considers to be the keywords for task list purposes.

FIG. 1 shows that the illustrated embodiment, as well as other disclosed embodiments, may include the step of the TME importing and displaying the action items from various action item communications, such as email, SMS, etc. into a central task list (Step 110).

FIG. 4 shows an example interface using the disclosed structure that may be used for importing the action items from various action item communications, such as email, SMS, etc. into a central task list (Step 110). By flagging the email so that the TME will import it into the user's task list, the steps of using a handwritten “to to” list, manually moving the action item from the email to the to-do list and tracking all things that need to be accomplished is bypassed.

In this example embodiment, the email may be flagged to import into the to-do list by checking a check box that is integrated into the email received. Action items may be originated from email, voicemails, text messages, or even just thoughts that come to mind. The requirements are bypassed which would require the person to write down, move or enter a task into their online calendar or task list tool once they receive the email, voicemail, etc.

In this example, when the email is flagged to import into the task list, the software module logic selecting keywords by the user or TME as disclosed may be used to determine which words to import into the task list. These words may be arranged in such a way that they are a task list item that can be read by the user. For example, as highlighted, the phrase would read “Grandma's birthday this week buying flowers Thursday,” which has all keywords but is difficult to read. The system may rearrange these keywords to read “Buy flowers for Grandma's birthday,” as illustrated, thereby making the task list more readable.

The action item may then be added to the task list as an incomplete task (shown here by an unchecked checkbox). If the TME logic determines a deadline for the action item, by parsing the keywords from the action item communication (in this case “Thursday” of “this week.”), the action item may be added to the electronic calendar as a calendar item as well as a task list item (not shown in FIG. 4).

After tasks are imported from action item communications, the TME may extract key words and search for suggested solutions to accomplish the task list items. The TME may suggest such solutions based on the users profile preferences and past actions, available partnership solutions, such as discounts or promotions, or available Internet search tools.

For example, the TME may recognize that the task “Buy flowers for Grandma's birthday” has not been marked as complete. As such, the TME may recognize that a proposed solution should be recommended to the user, John. To recommend this solution, the TME may refer to John's history with the TME (possibly stored in data storage 230) to determine possible solutions, possibly stored as past actions, ratings, decisions, preferences, etc. in the data storage 230. The TME may also search available partnership solutions, such as flower vendors currently running specials or promotions, or may use Internet search tools to find solutions on the Internet.

FIG. 3 shows that the illustrated embodiment, as well as other disclosed embodiments, may include the step of proposing a solution based on the user's existing profile, defined preferences, or past actions (Step 310).

FIGS. 4 and 6 show example interfaces using the disclosed structure that may be used for proposing a solution based on the user's existing profile, defined preferences, or past actions (Step 310). For example, the TME may use the extracted keywords “buy” and “flowers” to search John's preferences, possibly based on John's selecting an appropriate check box.

As described below, the user may have previously selected vendors from among a plurality of partners. In the example embodiments in FIGS. 4 and 6, the user may have been presented with a plurality of vendors and/or partners, and the user may have selected from among these vendors.

In the example embodiment in FIG. 6, the user may have selected 1-800-FLOWERS.COM as a partner for suggested solutions for tasks within the task list. In addition, as seen in FIG. 6, the user may have given the vendor/partner a high rating in previous interactions with this vendor/partner, or otherwise indicated a preferred vendor through either actions or choices. In this example, flowers are needed for the user's action items, and software logic and data within the TME may be used to coordinate this suggested solution based on the user's existing profile and previous preferences.

Another embodiment may include the step of proposing a solution based on the user's history, preferences and TME logic which ties together suggestions and behavior trends to suggest a solution.

In this example, flowers are needed for the user's action items, and logic and data within the TME may be used to coordinate the suggestion based on the user's existing profile and previous preferences, behaviors, attitudes, responsiveness, etc.

FIG. 3 shows that the illustrated embodiment, as well as other disclosed embodiments, may include the step of proposing a solution based on available partnership solutions (Step 310). For example, the TME system may use the extracted keywords “buy” and “flowers” to search a plurality of available partnership solutions, such as discounts or promotions, possibly based on John's selecting an appropriate check box.

One embodiment may include the step of proposing a solution based on available partner solutions (Step 310). As described below, the user may have previously selected vendors from among a plurality of partners. FIGS. 4 and 6 show an example interface using the disclosed structure that may be used for proposing a solution based on the user's profile defined preferences and available partnership solutions (Step 310). The TME system may recognize that the task “Buy flowers for Grandma's birthday” has not been marked as complete. As such, the TME may recognize that a proposed solution should be recommended to the user, John. In this example, the TME may recommend a partner-based solution including a current discount of 20% off at 1-800-FLOWERS.COM.

To accomplish this, the TME system may manage a list of partnerships and partner-based offerings (such as discounts or promotions) to present to users based on task list items. An entire database may be maintained in the data center 240 or partner data center 250 or via a link between the data centers, and the user may be presented these partner-based offerings to select their preferences, which may be stored in data storage 230. Likewise, the TME system may monitor preferences and selected solutions to determine which partners and Internet search tools are most used by the user, and present these to the user in subsequent offerings as preferred partners, vendors and/or Internet search tools.

The environment seen in FIG. 2 may be used to access information about one or more partner promotions using software, data and/or processes on or communicatively coupled to a partner's server 210 and data storage 230 in a partner's data center 250. The servers 210, data storage 230 and/or any software modules contained in the data center 240 or partner's data center 250 may be linked and/or synchronized so that, as a non-limiting example, the data, software and/or hardware for the electronic calendar in the data center 240 may allow the data, software and/or hardware in the partner's data center 250 to determine if discounts or promotions are available for the task list item.

As seen in FIG. 4, the user is not bound by the proposed solution as displayed to the user. In this example embodiment, a list of alternate solutions to the action item or task in the task list may be proposed to the user, based on other partnerships. For example, FlowerVendor2.com or FlowerVendor3.com may also be used to buy grandma's flowers if the user does not choose the original proposed solution.

Another embodiment may include the step of proposing a solution based on available Internet search tools (Step 310). One of these resources may include one or more Internet search tools. For example, as seen in FIG. 4, the user may select a proposed solution based, in addition to other options, on one or more Internet search tools, possibly by selecting an appropriate check box. As described below, the user may have previously selected such search tools from among a plurality of Internet search tools.

One of these resources may include a user's preferences, including Internet search tools. For example, as seen in FIG. 4, the user may select a proposed solution based on an Internet search. In the example embodiments in FIGS. 4 and 6, the user may have been presented with a plurality of search tools, and the user may select from among these search tools. In this example embodiment in FIG. 6, the user may have selected Search Tool 1 as a search tool for suggested solutions for tasks within the task list. In addition, the user may have given the search tool a high rating in previous interactions with this search tool.

As seen in FIG. 4, the user may select any combination of solutions based on user profile, partner solutions or Internet search. Thus any of these solutions can also be used together to provide an optimum suggestion for solutions to the user.

FIG. 1 shows that the illustrated embodiment, as well as other disclosed embodiments, may include the step of the system managing deadlines for tasks as needed (Step 130).

FIG. 4 shows an example interface using the disclosed structure that may be used for managing deadlines for tasks as needed (Step 130). For example, the proposed solution illustrated in FIG. 4 shows that the task within the task list needs to be completed by Thursday. As previously disclosed, the TME may include logic to allow the user to be informed of the deadline by parsing certain keywords from the original communication. However, the user may also use the calendar component of the electronic calendar (not shown) to set their own deadlines for the completion of the task within the task list. If this is the case, the TME may use this input calendar deadline (possibly imported into the task list itself) to determine the due date of the task and display the appropriate managed deadlines for the task.

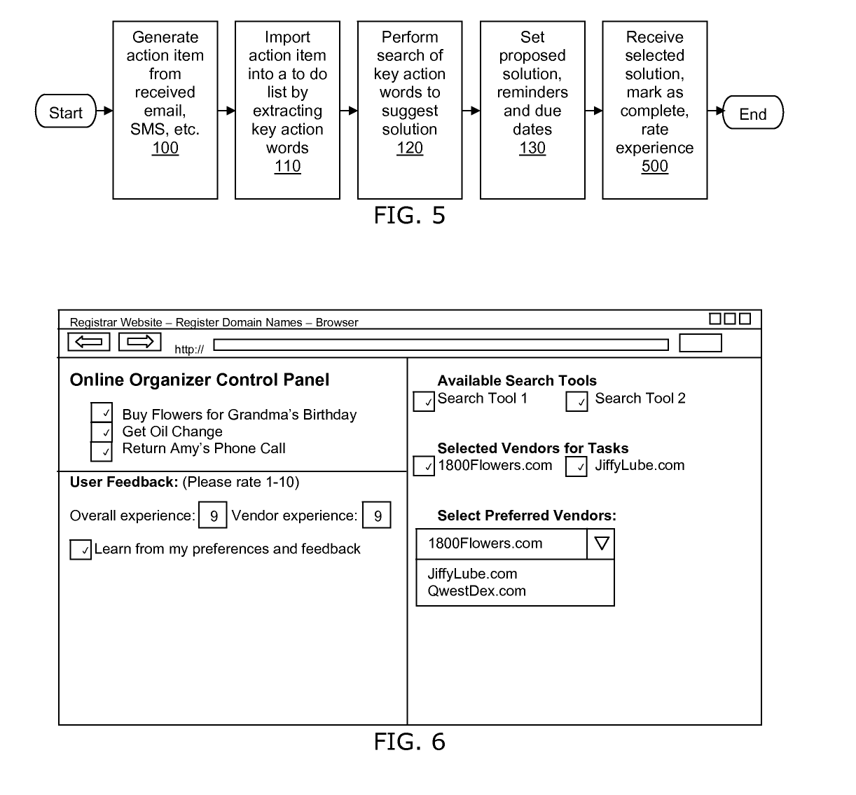

FIG. 5 shows that the illustrated embodiment, as well as other disclosed embodiments, may include the step of a user choosing a solution and the user or the TME marking the task complete with feedback to help the system learn preferences for future suggestions (Step 500).

FIGS. 4 and 6 show example interfaces using the disclosed structure that may be used for choosing a solution and the user or the TME marking the item complete with feedback to help the system learn preferences for future suggestions (Step 500). For example, in the embodiment illustrated in FIG. 4, the TME may recognize that proposed solutions have already been suggested for getting an oil change and returning Amy's phone call, as shown by these task list items being marked as complete. Similar solutions, using any of the embodiments described, may have been used to propose and select similar solutions for these task list items as are described above.

Assuming that John selects the proposed solution of 20% off flowers from the suggested or alternate partners/vendors, the system may automatically mark the item “Buy flowers for Grandma's birthday” as complete as seen in FIG. 6. In another embodiment, the user may manually mark the item as complete.

FIG. 5 shows that the illustrated embodiment, as well as other disclosed embodiments, may include the step of the user buying the suggested item and checking the task off on his to do list with a rating of the experience with the vendor, search tool, or user preferences he chose. (Step 500).

FIGS. 4 and 6 shows example interfaces using the disclosed structure that may be used for buying the suggested item and checking the task off on his to do list with a rating of his experience with the vendor, search tool, or user preferences he chose. (Step 500). For example, John may buy the flowers and check the task off on his to do list with a rating of his experience with the vendor he chose.

The ratings are not limited to the overall or vendor experience, as shown. In other embodiments, any element of the user experience may be rated, including, but not limited to, the Internet tool experience, effectiveness of the suggested solution, effectiveness of the parsed action item, etc. Thus, the feedback from the user may be used not only to allow the TME system to learn from the user's preference, but may also be used to improve the system overall.

As seen in the examples for the oil change and call returned to Amy, the TME may use the hardware, software and data from the data center, or any related data centers, to learn from the user's actions. As a non-limiting example, if the system notices that John is changing the oil every 6 months, the system may learn that John needs a reminder for that particular task every 6 months. The appropriate data may be updated in John's TME profile and stored using logic within related software modules to remind John every 6 months to change his oil and to search appropriate partners, Internet or profile information to recommend a best solution to John to make sure he gets the oil changed in an efficient manner.

Likewise, if the TME software modules were to learn that John is scheduling certain events, such as anniversaries or birthdays on certain days each year, the logic for the TME and the related software modules may learn from John's schedule to know which days to schedule related shopping, meals, and which partners John uses the most to recommend the solutions for the action items to best meet his needs.

The user may have control over whether or not the system learns from the user's preferences or feedback as seen in FIG. 6. The user may prefer to keep the preferences and experiences static, meaning the system only offers the user's preferences and does not change over time. If this option is selected by the user, the TME system will not learn from and change the offerings for solutions to the task over time.

As seen in FIG. 6, the user may have access to a user interface that allows the user to customize their experience with the TME. This interface may be presented to the user before or after the action item has been acted on the by the user. For example, the user may want to be offered partner-based offerings only from selected partners or vendors. In order to accomplish this, the user may be able to select from among the partners and/or vendors stored within the data storage 230, and the user's preferences may likewise be stored in data storage 230.

FIG. 6 shows that the customized user experience is not limited to partners or vendors. Non-limiting examples of elements of the system that can be customized in FIG. 6 also shows that the TME may allow the user to select from among available search tools and may put their preferences into rankings, possibly by selecting preferred elements of the system. However, even the illustrated examples are not limiting. Embodiments may be envisioned in which any element of the TME system may be customized to make the system as efficient as possible for the user.

The additional steps included in the embodiments illustrated in FIGS. 1-6 are not limited to the embodiment shown in FIG. 1 and may be combined in several different orders and modified within multiple other embodiments.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A method, comprising the steps of:
a) generating an action item from an action item communication received on a client communicatively coupled to a network;
b) importing the action item as a task into a task list of an electronic organizer hosted on a server in a data center;
c) extracting one or more keywords from the action item;
d) searching for a proposed solution for the task using the one or more keywords; and
e) displaying the proposed solution for the task to a user on a user interface on the client, wherein a task management engine learns from the user's response to the proposed solution and updates a profile for the user accordingly.

2. The method of claim 1 wherein the action item communication is an email.

3. The method of claim 1 wherein the action item communication is a voicemail.

4. The method of claim 1 wherein the action item communication is a text message.

5. The method of claim 1 wherein the action item communication is received by the user and the action item must be completed by the user by the end of a current time period.

6. The method of claim 1 further comprising the step of receiving a flag from the user indicating intent by the user to import the action item communication as a task into the task list.

7. The method of claim 1 further comprising the step of parsing a text string from the action item communication into the one or more keywords.

8. The method of claim 1 further comprising the step of rearranging the one or more keywords imported into the task list to make the task more readable to the user.

9. The method of claim 1 wherein the task imported into the task list is initially marked as incomplete.

10. The method of claim 1 further comprising the step of proposing a solution for the task based on the user's existing profile, defined preferences, past actions or any combination thereof.

11. The method of claim 10 wherein the past actions of the user include a behavior pattern of the user.

12. The method of claim 1 further comprising the step of proposing the solution for the task based on one or more available partnership solutions.

13. The method of claim 1 further comprising the step of proposing the solution for the task based on available Internet search tools.

14. The method of claim 1 further comprising the step of managing a deadline for the task.

15. The method of claim 1 further comprising the step of marking the task as complete.

16. The method of claim 1 further comprising the step of receiving feedback from the user, wherein the feedback is used by the task management engine to learn preferences, behavior patterns or any combination thereof from the user.

17. The method of claim 1 wherein the preferences and the behavior patterns are used to create future suggestions.

18. The method of claim 1 further comprising the step of receiving from the user a rating of the user's experience, the partner or vendor used, the usefulness of the proposed solution or any combination thereof.
